(19) United States
(12) Patent Application Publication
(10) Pub. No.: US 2018/0373393 A1
(43) Pub. Date: Dec. 27, 2018

(54) Methods and Apparatuses for Detecting Touch Motion with Ultrasonic Sensors

(71) Applicant: QUALCOMM Incorporated, San Diego, CA (US)

(72) Inventors: Arye Lerner, Kfar Yona (IL); Lior Maor, Petah Tikva (IL); Gal Rotem, Hod Hasharon (IL); Meir Agassy, Ramat Gan (IL)

(21) Appl. No.: 15/952,206

(22) Filed: Apr. 12, 2018

Related U.S. Application Data
(60) Provisional application No. 62/525,179, filed on Jun. 26, 2017.

(51) Int. Cl. G06F 3/043; G06F 3/0488; G06F 3/044; G06K 9/00

(52) U.S. Cl. CPC G06F 3/0433; G06F 3/0488; G06F 2203/04106; G06K 9/0002; G06F 3/044

(57) ABSTRACT

Methods and apparatuses for detecting touch motion with ultrasonic sensors are disclosed. In one embodiment, a method of detecting a touch motion with an ultrasonic sensor in an imaging apparatus may include sensing a series of scanned ultrasonic images of the touch motion, removing common components in the series of scanned ultrasonic images, determining correlations among the series of scanned ultrasonic images, and determining the touch motion based on the correlations among the series of scanned ultrasonic images.

### CROSS REFERENCE TO RELATED APPLICATION

This application claims the benefit of U.S. patent application No. 62/525,179, “Methods and Apparatuses for Swipe Detection with Ultrasonic Sensors,” filed Jun. 26, 2017, which is assigned to the assignee hereof. The aforementioned United States patent application is hereby incorporated by reference in its entirety.

### FIELD

The present disclosure relates to the field of user interfaces. In particular, the present disclosure relates to detecting touch motion with an ultrasonic sensor.

### BACKGROUND

Fingerprint sensing and matching is a commonly used technique for personal identification or verification. For example, one approach to fingerprint identification involves scanning a sample fingerprint or an image with a biometric reader/sensor and storing the image and/or unique characteristics of the fingerprint image. The characteristics of a sample fingerprint may then be compared to information for reference fingerprints already in a database to determine proper identification of a person, such as for verification purposes.

As ultrasonic sensors have become increasingly popular in mobile devices, it is desirable to have apparatuses and methods for detecting touch motion with ultrasonic fingerprint sensors.

### SUMMARY

The present disclosure relates to methods and apparatuses for detecting touch motion with ultrasonic sensors. In one embodiment, a method of detecting a touch motion with an ultrasonic sensor in an imaging apparatus may include sensing a series of scanned ultrasonic images of the touch motion, removing common components in the series of scanned ultrasonic images, determining correlations among the series of scanned ultrasonic images, and determining the touch motion based on the correlations among the series of scanned ultrasonic images.

In another embodiment, an imaging apparatus configured to detect a touch motion with an ultrasonic sensor may include an ultrasonic sensor configured to sense a series of scanned ultrasonic images of the touch motion, a memory configured to store the series of scanned ultrasonic images, and a controller configured to remove common components in the series of scanned ultrasonic images, determine correlations among the series of scanned ultrasonic images, and determine the touch motion based on the correlations among the series of scanned ultrasonic images.

### BRIEF DESCRIPTION OF THE DRAWINGS

The aforementioned features and advantages of the disclosure, as well as additional features and advantages thereof, will be more clearly understandable after reading detailed descriptions of embodiments of the disclosure in conjunction with the non-limiting and non-exhaustive aspects of the following drawings. Like numbers are used throughout the figures.

FIG. 1A illustrates an exemplary block diagram of a mobile device according to aspects of the present disclosure.

FIG. 1B illustrates an exemplary implementation of the sensor subsystem of the mobile device of FIG. 1A according to aspects of the present disclosure.

FIG. 2A illustrates an exemplary implementation of detecting touch motion according to aspects of the present disclosure.

FIG. 2B illustrates another exemplary implementation of detecting touch motion according to aspects of the present disclosure.

FIG. 2C illustrates yet another exemplary implementation of detecting touch motion according to aspects of the present disclosure.

FIG. 3A illustrates an example of using a reduced scanned image area to detect a vertical swipe according to aspects of the present disclosure.

FIG. 3B illustrates an example of using a reduced scanned image area to detect a horizontal swipe according to aspects of the present disclosure.

FIG. 3C illustrates another example of using a reduced scanned image area to detect a swipe according to aspects of the present disclosure.

FIG. 4 illustrates an example of decision logic based on the correlation peak value location according to aspects of the present disclosure.

FIG. 5 illustrates an example of showing movement and direction of a swipe according to aspects of the present disclosure.

FIG. 6A illustrates a method of detecting touch motion according to aspects of the present disclosure.

FIG. 6B illustrates a method of removing the mean from a series of scanned ultrasonic images according to aspects of the present disclosure.

FIG. 6C illustrates a method of summing and diluting a series of scanned ultrasonic images according to aspects of the present disclosure.

FIG. 6D illustrates a method of removing common components from a series of scanned ultrasonic images according to aspects of the present disclosure.

FIG. 6E illustrates a method of determining a touch motion based on correlations among the series of scanned ultrasonic images according to aspects of the present disclosure.

FIG. 6F illustrates another exemplary method of determining a touch motion according to aspects of the present disclosure.

FIG. 7 illustrates an exemplary block diagram of a device that may be configured to implement touch motion detection according to aspects of the present disclosure.

FIGS. 8A-8C illustrate an example of an ultrasonic sensor according to aspects of the present disclosure.

FIG. 9A illustrates an example of a four-by-four array of sensor pixels for an ultrasonic sensor array according to aspects of the present disclosure.

FIG. 9B illustrates an example of a high-level block diagram of an ultrasonic sensor system according to aspects of the present disclosure.

### DESCRIPTION OF EMBODIMENTS

Embodiments of methods and apparatuses for detecting touch motion with ultrasonic sensors are disclosed. The following descriptions are presented to enable a person skilled in the art to make and use the disclosure. Descriptions of specific embodiments and applications are provided only as examples. Various modifications and combinations of the examples described herein may be readily apparent to those skilled in the art, and the general principles defined herein may be applied to other examples and applications without departing from the scope of the disclosure. Thus, the present disclosure is not intended to be limited to the examples described and shown, but is to be accorded the scope consistent with the principles and features disclosed herein. The word “exemplary” or “example” is used herein to mean “serving as an example, instance, or illustration.” Any aspect or embodiment described herein as “exemplary” or as an “example” is not necessarily to be construed as preferred or advantageous over other aspects or embodiments.

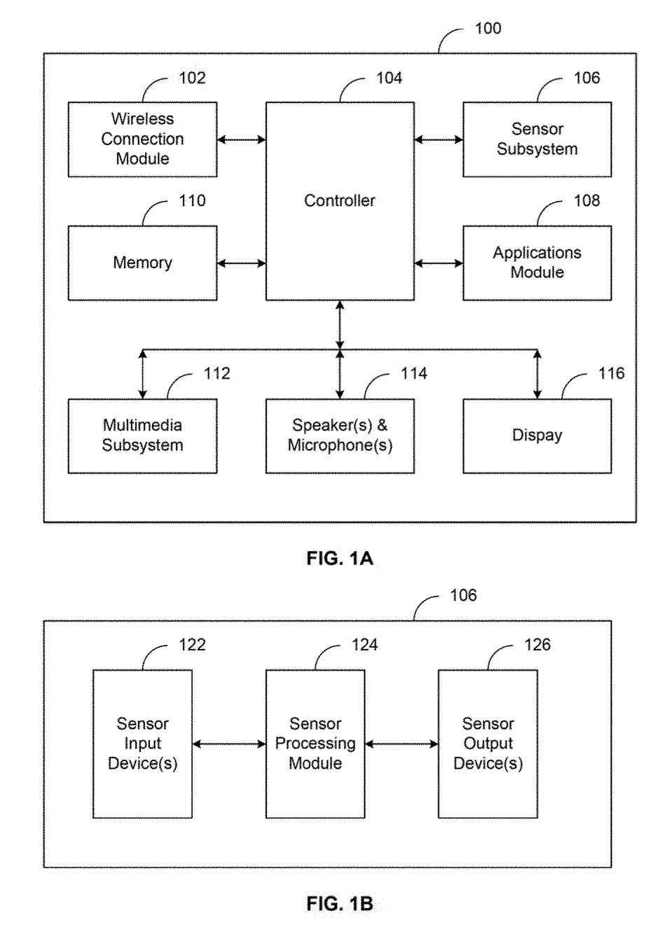

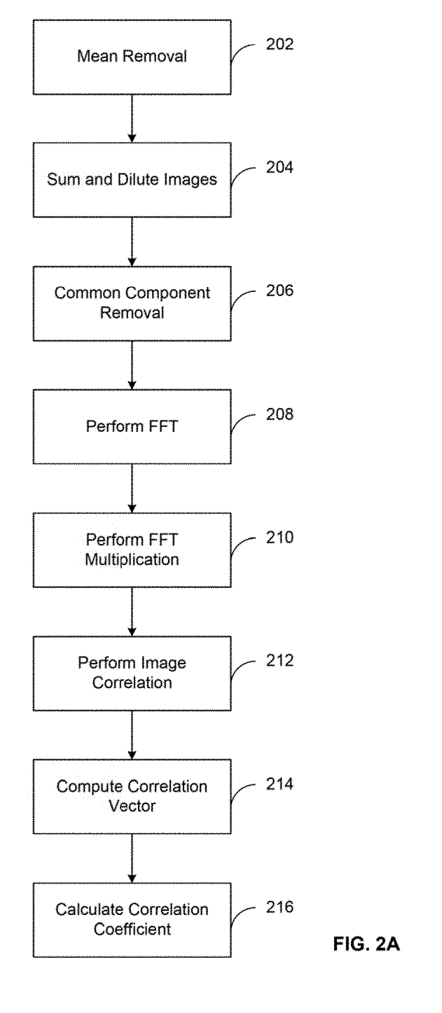

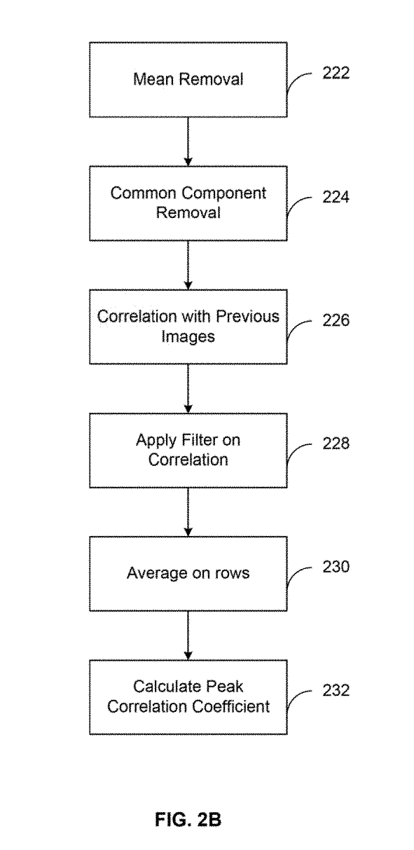

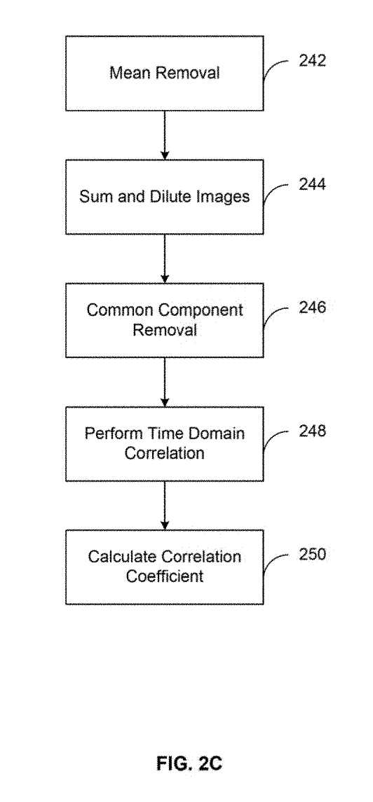

FIG. 1A illustrates an exemplary block diagram of a mobile device according to aspects of the present disclosure. In the example shown in FIG. 1A, an imaging apparatus 100 (also referred to as a mobile device) may include wireless connection module 102, controller 104, sensor subsystem 106, memory 110 and applications module 108. The imaging apparatus 100 may optionally include multimedia subsystem 112, speaker(s) and microphone(s) 114, and display 116. In some implementations, the wireless connection module 102 may be configured to support WiFi and/or Bluetooth in a wireless local area network (LAN) or wireless personal area network (PAN). The controller 104 may include one or more processors, software, hardware, and firmware to implement various functions described herein. For example, the controller 104 may be configured to implement functions of the imaging apparatus 100 as described in FIG. 2A-2C to FIG. 6A-6F. The sensor subsystem 106 may be configured to sense and process various sensor input data and produce sensor output data to the controller 104. The applications module 108 may include a battery charging circuit and power manager, oscillators, phase lock loops, clock generators and timers.

In some implementations, the sensor subsystem 106 may be configured to sense and detect a swipe motion in low power conditions. For example, the sensor subsystem 106 may be configured to include a sensor having a plurality of sensor pixels, such as an 80 pixels by 180 pixels detector configuration, to determine a swipe motion of a finger or a stylus. In some other implementations, different sensor configurations with different sensor areas may be employed.

In certain embodiments, imaging apparatus 100 may include a wireless transceiver that is capable of transmitting and receiving wireless signals via a wireless antenna over a wireless communication network. Some embodiments may include multiple wireless transceivers and wireless antennas to enable transmitting and/or receiving signals according to corresponding multiple wireless communication standards such as, for example, versions of IEEE Std. 802.11, CDMA, WCDMA, LTE, UMTS, GSM, AMPS, Zigbee and Bluetooth, etc.

In various embodiments, controller 104 may be configured to execute one or more machine-readable instructions stored in memory 110 such as on a computer-readable storage medium, such as RAM, ROM, FLASH, or disc drive, just to name a few examples. The one or more instructions may be executable by one or more processors, specialized processors, or DSPs. Memory 110 may include a non-transitory processor-readable memory and/or a computer-readable memory that stores software code (programming code, instructions, etc.) that are executable by the processors and/or DSPs to perform functions described herein. Controller 104 may execute instructions to perform one or more aspects of processes/methods discussed below in connection with FIG. 2A to FIG. 6.

In some implementations, a user interface may include any one of several devices such as, for example, multimedia subsystem 112, speakers and microphones 114, display 116, etc. In a particular implementation, the user interface may enable a user to interact with one or more applications hosted on imaging apparatus 100. For example, devices may store analog or digital signals in memory 110 to be further processed by controller 104 in response to an action from a user. Similarly, applications hosted on imaging apparatus 100 may store analog or digital signals on memory 110 to present an output signal to a user.

Imaging apparatus 100 may also include a camera for capturing still or moving imagery. The camera may include, for example, an imaging sensor (e.g., charge coupled device or CMOS imager), lens, analog to digital circuitry, frame buffers, etc. In some implementations, additional processing, conditioning, encoding or compression of signals representing captured images may be performed by controller 104. Alternatively, a video processor may perform conditioning, encoding, compression or manipulation of signals representing captured images. Additionally, the video processor may decode/decompress stored image data for presentation on display 116 of imaging apparatus 100.

FIG. 1B illustrates an exemplary implementation of the sensor subsystem of the imaging apparatus of FIG. 1A according to aspects of the present disclosure. Sensor subsystem 106 may generate analog or digital signals that may be stored in memory 110 and processed by controller 104 in support of one or more applications such as, for example, applications relate to activating a device based on detection of a fingerprint image.

As shown in FIG. 1B, the sensor subsystem 106 may include one or more sensor input devices 122, sensor processing module 124, and one or more sensor output devices 126. The one or more sensor input devices 122 may include a sensor for fingerprint image and/or detecting touch motion as described above in association with FIG. 1A. The one or more sensor input devices 122 may also include one or more ultrasonic sensors, temperature and moisture sensors, capacitive sensors, microphones, ultrasound microphone arrays, photo detectors, image sensors, touch sensors, pressure sensors, chemical sensors, gyroscopes, accelerometers, magnetometers, GPS and compass. The sensor processing module 124 may be configured to perform one or more of the following functions, including but not limited to: input sensor selection and control, synchronization and timing control, signal processing, sensor platform performance estimation, sensor optimization, sensor fusion, and output sensor/device selection and control. The one or more sensor output devices 126 may produce one or more ultrasonic, voice, visual, biometric, nearness, presence, pressure, stability, vibration, location, orientation, heading, kinetics, electrical and chemical signals. The sensor subsystem 106 may be configured to implement functions of operating a device based on detection of a series of scanned images as described in FIG. 2A to FIG. 6. In some implementations, ultrasonic sensors may be configured to measure capacitance values of a touch motion. In some implementations, one or more capacitive sensors may be configured to measure capacitance values of the touch motion. In some implementations, the measurements by the ultrasonic sensors and the capacitive sensors may be combined to determine the capacitance values of the touch motion.

The sensor processing module 124 may be configured to process sensor input data from the one or more sensor input devices 122, and produce output commands or signals to the one or more sensor output devices 126 and/or to the one or more optional active sensor output devices. According to aspects of the present disclosure, direct user inputs may be used to predictably manipulate power control behavior. In some embodiments, a mobile device may be configured to accept user commands (via direct, voice/aural and/or visual inputs) and be configured to sense a multitude of use, use environment and use contexts. In some implementations, the ultrasonic sensor can support gestures, that is, movements such as left/right/up/down, single or double taps, or press-and-hold motions that can be used to activate certain functions more quickly such as taking pictures.

In some implementations, the sensor processing module 124 may include an application-specific integrated circuit (ASIC) that includes circuitry such as a plurality of voltage regulators for generating a plurality of power supply voltages; memory, finite-state machines, level shifters and other associated circuitry for generating control signals to an ultrasonic sensor having a plurality of sensor pixels; circuitry for generating transmitter excitation signals, range-gate delay signals, diode bias signals and receiver bias signals to the ultrasonic sensor; circuitry for analog signal conditioning, analog-to-digital conversion and digital processing of the received pixel output signals from the ultrasonic sensor, and interface circuitry for sending digital output signals to an applications processor of a mobile device. The applications processor may execute the methods described in this disclosure.

In other implementations, in addition to the ASIC circuitry described in the prior paragraph, the ASIC may also include a microcontroller to autonomously execute one or more initial stages of the disclosed methods and processes locally on the ASIC. For low power operations, it may be desirable that the microcontroller make determinations before requesting and enlisting the processing resources of the applications processor and other components of the mobile device.

In yet other implementations, in addition to the microcontroller and ASIC circuitry noted above, the ASIC may also include an ultrasonic sensor pixel array and associated circuitry such as row-drivers and column-gate drivers to scan the pixels. In these implementations, the ASIC may execute the functions of sensing the sensor pixel output signals in addition to the functions of finger presence detection and other functions described herein.

FIG. 2A illustrates an exemplary implementation of detecting touch motion according to aspects of the present disclosure. In this exemplary implementation, a series of images may be scanned sequentially and a controller of an apparatus for detecting touch motion may be configured to recognize image shifts as movements and detect user commands in response to the image shifts.

In block 202, the controller may be configured to perform mean removal from the series of scanned images. In an exemplary implementation, for an image size of n×m pixels, the mean values may be removed from each row of n pixels. Mean value removal may be performed on every scanned image. This method of mean removal may be computed with the following expression.

$$∀ x , y {\tilde{I}}_{x , y} = {I}_{x , y} - \frac{{\sum }_{{x}^{′} = 1}^{n} {I}_{{x}^{′} , y}}{n}$$

Similarly, mean values may be removed from each column of m pixels. This removal may be performed on every scanned image. This method of mean removal may be computed with the following expression.

$$∀ x , y {\tilde{I}}_{x , y} = {I}_{x , y} - \frac{{\sum }_{{y}^{′} = 1}^{m} {I}_{x , {y}^{′}}}{m}$$

Similarly, mean values may be removed from selected areas of the scanned area of n×m pixels. This removal may be performed on every scanned image. This method of mean removal may be computed with the following expression.

$$∀ i {\tilde{I}}_{i} = {I}_{i} - \frac{{\sum }_{i = 1}^{n * m} {I}_{i}}{n * m}$$

where n is the number of rows and m is the number of columns.

In block 204, the controller may be configured to perform summation and dilution of the series of images. In some embodiments, the following expression may be applied to each row or column in a scanned image.

$$∀ k = 1 , 6 , 12 , … , ( m - 1 ) * 6 , m * 6 , {\tilde{R}}_{k} = {\sum }_{{y}^{′} = 1}^{6} {R}_{k + {y}^{′}}$$

where k is the new (diluted) pixel index in the row or column.

In block 206, the controller may be configured to perform common component removal. In some embodiments, for k consecutively scanned images, the following expression may be used for common component removal.

$$∀ i = 1 \to n * m , {\tilde{I}}_{{k}_{i}} = {I}_{{k}_{i}} - \frac{{\sum }_{k = 1}^{4} {I}_{{k}_{i}}}{4}$$

where i is the pixel number.

In some implementations, one aspect of common component removal may be to estimate and remove common background information in the series of scanned ultrasonic images. For example, a controller may be configured to estimate a background energy received by the ultrasonic sensor array without the finger being present on the platen and remove the estimated background energy from the reflected acoustic energy of the finger.

For example, in performing background estimation, the controller may be configured to determine an acquisition time delay (also referred to as range gate delay) and an ultrasonic transmitter frequency in accordance with a variation of a current temperature from a reference temperature from which an initial background estimation and an initial ultrasonic transmitter frequency are determined. The ultrasonic sensor array may be configured to acquire background image information based on the acquisition time delay and the ultrasonic transmitter frequency. Then, the controller may be configured to compute the background estimate using the background image information.

According to aspects of the present disclosure, background estimation may be determined as follows:

Im_{fg}=Im_{fg}_{_}ₒₙ−Im_{fg}_{_}_{off}

Im_{bg}=Im_{bg}_{_}ₒₙ−Im_{bg}_{_}_{off}

where Im_{fg}_{_}ₒₙ is the image captured with a finger on the platen of the ultrasonic sensor and with the ultrasonic transmitter being activated; Im_{fg}_{_}_{off} is the image captured with a finger on the platen of the ultrasonic sensor and with the ultrasonic transmitter being disabled; Im_{bg}_{_}ₒₙ is the image captured without any object on the platen of the ultrasonic sensor and with the ultrasonic transmitter being activated; and Im_{bg}_{_}_{off} is the image captured without any object on the platen of the ultrasonic sensor and with the ultrasonic transmitter being disabled.

In one embodiment, an estimate of the background image may be obtained by subtracting the background image Im_{bg} from the foreground image Im_{fg}. In another embodiment, an estimation of the background image may be obtained by projecting the foreground image on an orthogonal basis that spreads the space of recorded background images. This estimation is then subtracted from Im_{fg} to produce the scanned images.

In some implementations, an exemplary method of performing background estimation may determine an updated acquisition time delay and an updated ultrasonic transmitter frequency in accordance with a variation of a current temperature relative to a reference temperature from which an initial background estimation and an initial ultrasonic transmitter frequency may be determined. The method may acquire background image information based on the updated acquisition time delay and the updated ultrasonic transmitter frequency. The method may then compute the background estimation using the background image information.

Optionally or additionally, the method may perform at least one of: reducing background noise based on autocorrelation of the pixels in the set of scanned ultrasonic images; reducing sensor artifacts by removing quiescent values in the sampled data; or a combination thereof. In one implementation, autocorrelation of the pixels in the set of scanned ultrasonic images may be performed with a shift or lag of one or more pixels in the direction of the touch motion.

In block 208, the controller may be configured to perform a Fast Fourier Transform (FFT) to convert the series of images into the frequency domain.

In block 210, the controller may be configured to perform multiplication of two adjacent images of the transformed images in the frequency domain.

In block 212, the controller may be configured to perform an inverse FFT to determine correlations among the two adjacent images. The correlation can be two dimensional with multiple rows, or one dimensional per row. In some embodiments, the following expressions may be used to determine the correlation between two adjacent, for example n^{th} and n^{th}−1, images.

C(I)= [symbol] ⁻¹( [symbol] (Iₙ)* [symbol] +(Iₙ₋₁))

In block 214, the controller may be configured to compute one or more correlation vectors for the series of images. In some embodiments, correlation between n^{th} and n^{th}+1 images for the y^{th} row may be computed with the following expression.

$${V}_{y} [ m ] = {\sum }_{x = 0}^{M - 1} {I}_{x , y}^{n} * {I}_{x + m , y}^{n + 1}$$

where M is the row length in pixels.

In addition, image energy may be calculated on diluted images with the following expression.

$$E = {\sum }_{i = 1}^{n * m} {( {I}_{i} )}^{2}$$

In block 216, the controller may be configured to calculate one or more correlation indexes and/or coefficients. In some embodiments, the correlation index may be determined using the following expression.

idxmax=Argmax(V)

where a condition for a left swipe is determined with the expression:

Idx>length(V)/2

and where a condition for a right swipe is determined with the expression:

Idx<length(V)/2

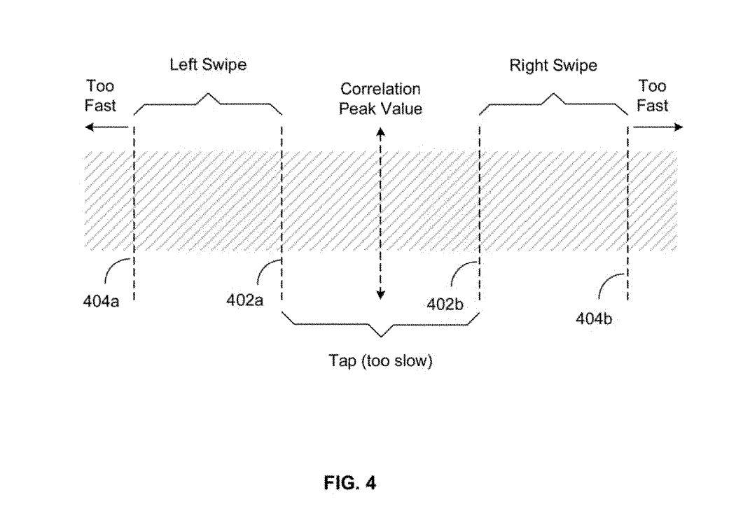

The following expression may be used to calculate the correlation coefficient between n^{th} and n^{th}+1 images. The correlation coefficient may be used to evaluate the quality of correlation peak values among the series of images, which is further described in association with FIG. 4 below.

$${Coeff}_{n , n + 1} = \frac{{V}_{idxmax}^{n , n + 1}}{{E}_{n} * {E}_{n + 1}}$$

FIG. 2B illustrates another exemplary implementation of detecting touch motion according to aspects of the present disclosure. In the example shown in FIG. 2B, a series of images may be scanned sequentially and a controller of an apparatus for detecting touch motion may be configured to recognize image shifts as movements and detect user commands in response to the image shifts. In block 222, the controller may be configured to perform mean removal from the series of scanned images. In block 224, the controller may be configured to remove common components from the series of scanned images. In block 226, the controller may be configured to determine correlations among the series of scanned images. In block 228, the controller may be configured to apply a filter on the correlated images. In block 230, the controller may be configured to compute an average on the rows (or columns for a vertical swipe). In block 232, the controller may be configured to calculate a peak correlation coefficient of the series of scanned images.

FIG. 2C illustrates yet another exemplary implementation of detecting touch motion according to aspects of the present disclosure. In this example, a series of images may be scanned sequentially and a controller of an apparatus for detecting touch motion may be configured to recognize image shifts as movements and detect user commands in response to the image shifts.

In block 242, the controller may be configured to perform mean removal from the series of scanned images. In an exemplary implementation, for an image size of n×m pixels, removing the mean of the series of scanned images captured from a horizontal swipe may be computed with the following expression.

$$∀ x , y {\tilde{I}}_{x , y} = {I}_{x , y} - \frac{{\sum }_{{x}^{′} = 1}^{n} {I}_{{x}^{′} , y}}{n}$$

Removing the mean of a series of scanned images captured from a vertical swipe may be computed with the following expression.

$$∀ x , y {\tilde{I}}_{x , y} = {I}_{x , y} - \frac{{\sum }_{{y}^{′} = 1}^{m} {I}_{x , {y}^{′}}}{m}$$

Removing the mean of the entire scanned area of the series of scanned images may be computed with the following expression.

$$∀ i {\tilde{I}}_{i} = {I}_{i} - \frac{{\sum }_{i = 1}^{n * m} {I}_{i}}{n * m}$$

where n is the number of rows and m is the number of columns.

In block 244, the controller may be configured to perform summation and dilution of the series of images. In some embodiments, the following expression may be applied to each row in a scanned image.

$$∀ k = 1 , 6 , 12 , … , ( m - 1 ) * 6 , m * 6 , {\tilde{R}}_{k} = {\sum }_{{y}^{′} = 1}^{6} {R}_{k + {y}^{′}}$$

where k is the new (diluted) pixel index in the row.

In block 246, the controller may be configured to perform common component removal. In some embodiments, for k consecutively scanned images, the following expression demonstrates a use of K=4 frames for common component removal.

$$∀ i = 1 \to n * m , {\tilde{I}}_{{k}_{i}} = {I}_{{k}_{i}} - \frac{{\sum }_{k = 1}^{4} {I}_{{k}_{i}}}{4}$$

where i is the pixel number.

In some implementations, one aspect of common component removal may be to estimate and remove common background information in the series of scanned ultrasonic images. For example, a controller may be configured to estimate a background energy received by the ultrasonic sensor array without the finger being present on the platen, and remove the estimated background energy from the reflected acoustic energy of the finger.

For example, in performing background estimation, the controller may be configured to determine an acquisition time delay (also referred to as range gate delay) and an ultrasonic transmitter frequency in accordance with a variation of a current temperature from a reference temperature from which an initial background estimation and an initial ultrasonic transmitter frequency are determined. The ultrasonic sensor array of the ultrasonic sensor may be configured to acquire background image information based on the acquisition time delay and the ultrasonic transmitter frequency. Then, the controller may be configured to compute the background estimate using the background image information.

According to aspects of the present disclosure, background estimation may be determined as follows:

Im_{fg}=Im_{fg}_{_}ₒₙ−Im_{fg}_{_}_{off}

Im_{bg}=Im_{bg}_{_}ₒₙ−Im_{bg}_{_}_{off}

where Im_{fg}_{_}ₒₙ is the image captured with a finger on the platen of the ultrasonic sensor and with the ultrasonic transmitter being activated; Im_{fg}_{_}_{off} is the image captured with a finger on the platen of the ultrasonic sensor and with the ultrasonic transmitter being disabled; Im_{bg}_{_}ₒₙ is the image captured without any object on the platen of the ultrasonic sensor and with the ultrasonic transmitter being activated; and Im_{bg}_{_}_{off} is the image captured without any object on the platen of the ultrasonic sensor and with the ultrasonic transmitter being disabled.

In one embodiment, an estimate of the background image may be obtained by subtracting the background image Im_{bg} from the foreground image Im_{fg}. In another embodiment, an estimation of the background image may be obtained by projecting the foreground image on an orthogonal basis that spreads the space of recorded background images. This estimation is then subtracted from Im_{fg} to produce the scanned images.

In some implementations, an exemplary method of performing background estimation may determine an updated acquisition time delay and an updated ultrasonic transmitter frequency in accordance with a variation of a current temperature relative to a reference temperature from which an initial background estimation and an initial ultrasonic transmitter frequency may be determined. The method may acquire background image information based on the updated acquisition time delay and the updated ultrasonic transmitter frequency. The method may then compute the background estimation using the background image information.

Optionally or additionally, the method may perform at least one of: reducing background noise based on autocorrelation of the pixels in the set of scanned ultrasonic images; reducing sensor artifacts by removing quiescent values in the sampled data; or a combination thereof. In one implementation, autocorrelation of the pixels in the set of scanned ultrasonic images may be performed with a shift or lag of one or more pixels in the direction of the touch motion.

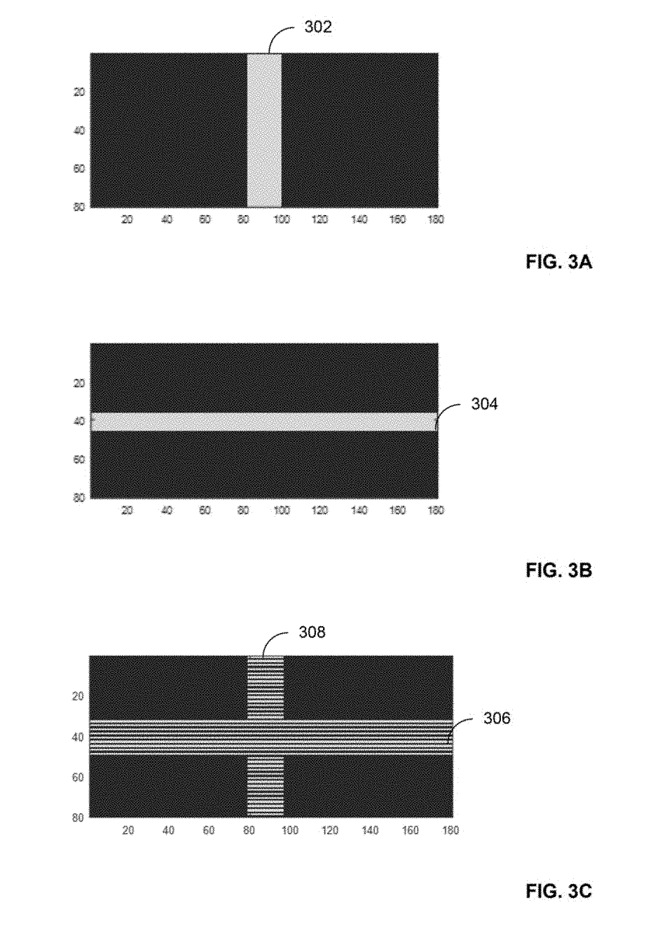

In block 248, the controller may be configured to perform time domain correlation on selected rows in a scanned image such as 304 shown in FIG. 3B or 306 shown in FIG. 3C, as well as perform time domain correlation on selected columns in a scanned image such as 302 shown in FIG. 3A or 308 shown in FIG. 3C.

In block 250, the controller may be configured to calculate one or more correlation indexes and/or coefficients. In some embodiments, the correlation index may be determined using the following expression.

idxmax=Argmax(V)

where a condition for a left swipe is determined with the expression:

Idx>length(V)/2

and where a condition for a right swipe is determined with the expression:

Idx<length(V)/2

The following expression may be used to calculate the correlation coefficient between n^{th} and n^{th}+1 images. The correlation coefficient may be used to evaluate the quality of correlation peak values among the series of images, which is further described in association with FIG. 4 below.

$${Coeff}_{n , n + 1} = \frac{{V}_{idxmax}^{n , n + 1}}{{E}_{n} * {E}_{n + 1}}$$

FIG. 3A illustrates an example of using a reduced scanned image area to detect a vertical swipe according to aspects of the present disclosure. In some embodiments, swipe detection may be activated when a home button event is recognized. Swipe detection may perform scans of a series of images sequentially. According to aspects of the present disclosure, common components of the series of scanned images can be considered as a background and may be removed from each scanned image.

In some implementations, partial images may be scanned with different scan patterns, each optimized to scan in a different direction. In the example of FIG. 3A, a vertical (up/down) scan direction 302 is shown. The numerals in the horizontal and vertical axes represent the pixel number along the horizontal and vertical axes. In this example, a reduced scanned image area of active pixels having a width of about 20 pixels is shown vertically in the middle of the sensing area. In this example, a more efficient implementation may be accomplished by ignoring or not scanning the black portion of the image.

FIG. 3B illustrates an example of using a reduced scanned image area to detect a horizontal swipe according to aspects of the present disclosure. Similar to the example shown in FIG. 3A, partial images may be scanned with different scan patterns, each scan pattern optimized to scan in a different direction. In the example of FIG. 3B, a horizontal (left/right) scan direction 304 is shown. The numerals in the horizontal and vertical axes represent the pixel number along the horizontal and vertical axes. In this example, a reduced scanned image area of active pixels having a width about 6 pixels is shown horizontally in the middle of the sensing area. In this example, a more efficient implementation may be accomplished by ignoring or not scanning the black portion of the image.

FIG. 3C illustrates another example of using a reduced scanned image area to detect a swipe according to aspects of the present disclosure. Similar to the examples shown in FIG. 3A and FIG. 3B, partial images may be scanned with different scan patterns, each optimized to scan in a different direction. In the exemplary implementation of FIG. 3C, sensor pixels in an ultrasonic sensor array may be active to enable readings in both horizontal and vertical directions. For example, a horizontal (left/right) scan direction 306 and a vertical (up/down) scan direction 308 may be supported. The numerals in the horizontal and vertical axes represent the pixel number along the horizontal and vertical axes. In this example, a reduced scanned image area of active pixels having a width of about 20 pixels is shown in both horizontal and vertical directions. In this example, a more efficient implementation may be accomplished by ignoring or not scanning the black portion of the image.

FIG. 4 illustrates an example of decision logic based on the correlation peak value location according to aspects of the present disclosure. The correlation peak value location may be used to indicate the finger movement speed on the sensor. In order to distinguish between a swipe and a tap, the correlation peak value location may be compared to a first threshold (also referred to as lower bound threshold). Correlation peaks with values that are below the first threshold, indicated by dotted lines 402a and 402b, may be considered to be a tap. Correlations peaks with values above the first threshold may be considered to be a swipe.

According to aspects of the present disclosure, a second threshold may be used to limit a maximum speed that the touch motion detection method may support. Peak values above this second threshold, indicated by dotted lines 404a and 404b, may not be considered a swipe, and the gesture may be ignored and a feedback message may be generated in response to the speed of the touch motion being larger than the second threshold. This implementation may decrease a false detection ratio by supporting swipes that are speed limited.

In the example shown in FIG. 4, the horizontal axis indicates the correlation peak value location. There is a relationship between the image sampling rate, the image resolution and the speed of the swipe. For example, if an image is sampled at a rate of 100 Hz, the resolution after decimation may be about 1 pixel every 0.3 mm and the swipe may be considered as a constant speed, then each value of the peak location corresponds to about 100*0.3=3 mm/second.

In some implementations, swipes that are less than about 3 mm/second may be rejected, such that the lower thresholds are set to be ±1 sample. In some implementations, if it is desirable to reject swipes with speeds greater than 30 cm/second, then an upper bound threshold may be selected to be ±10 samples.

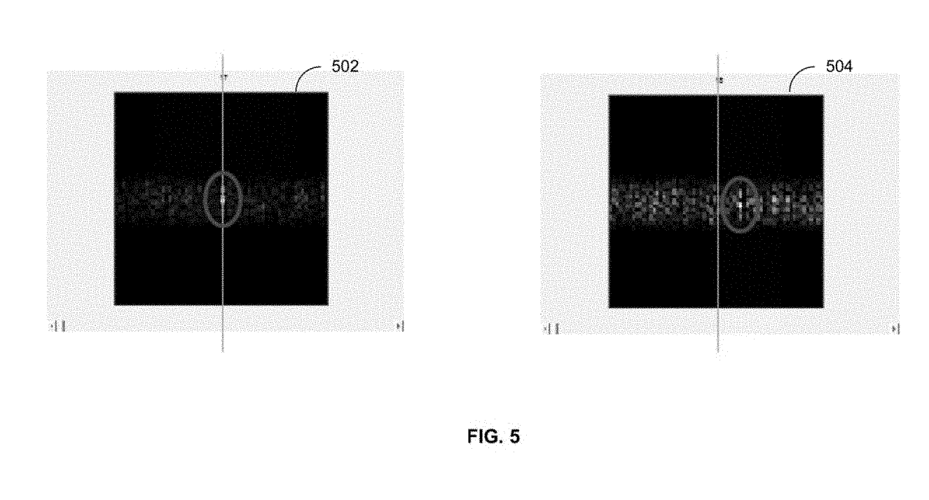

FIG. 5 illustrates an example of showing movement and direction of a swipe according to aspects of the present disclosure. In some implementations, correlations among a series of scanned images may be determined on objects of interest. For example, a controller of an image apparatus may be configured to detect objects or components with high gradients (such as edges, fingerprint features, a stylus tip, etc.). Then, the controller may be configured to perform the correlation on those regions.

In addition, the controller may be configured to check correlations among two consequent images, for example between n^{th} and n^{th}+2 images, to verify the direction of the swipe. FIG. 5 shows an example correlation picture with the image shifted to the right (labeled with numeral 504) versus no shift (labeled with numeral 502). In some implementations, edge filtering may be applied to the correlation result. The correlation result is then analyzed and used to determine an object's shift direction and length and/or speed of the swipe.

According to aspects of the present disclosure, the method of detecting touch motion does not require fingerprint image recognition, and the method may be used with any object such as a glove or a stylus pen. The disclosed method may be used to detect a swipe in any direction, and the speed of the swipe may also be determined. The swipe sequence may end when at least one of the following conditions is met: 1) movement detected by the ultrasonic sensor is stopped; and/or 2) the object is lifted.

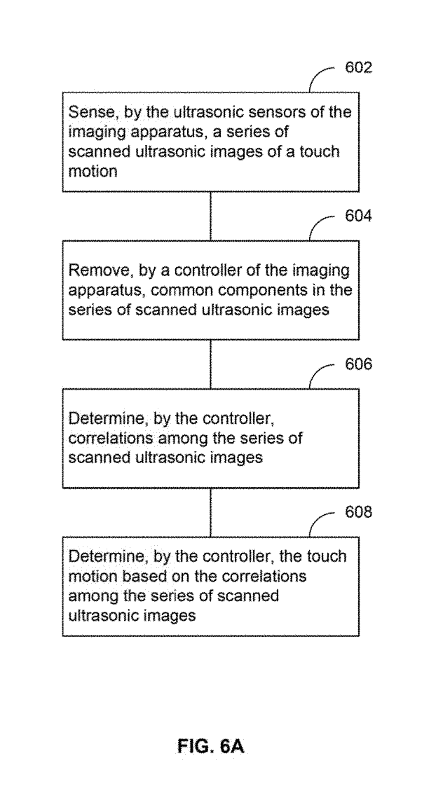

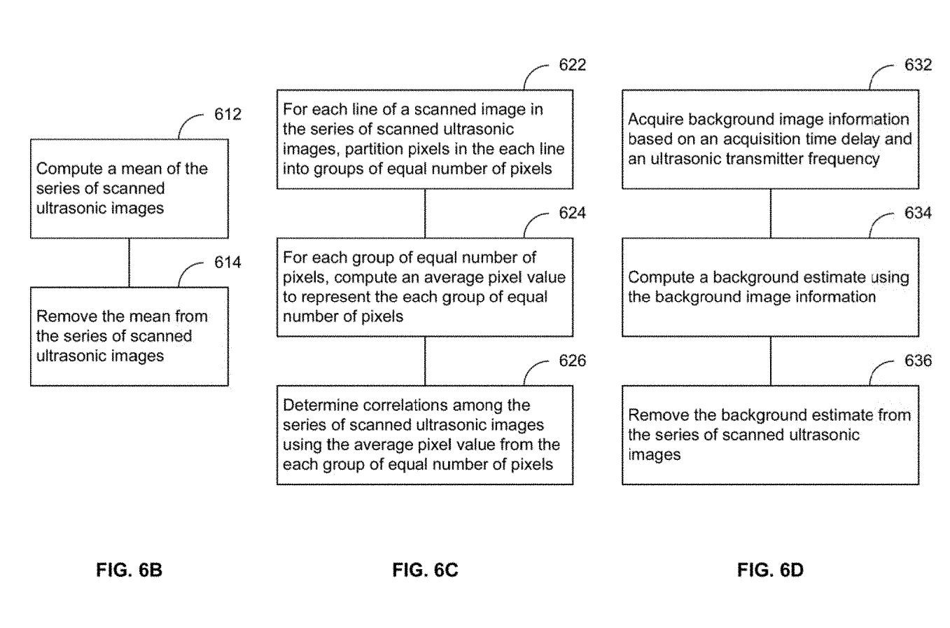

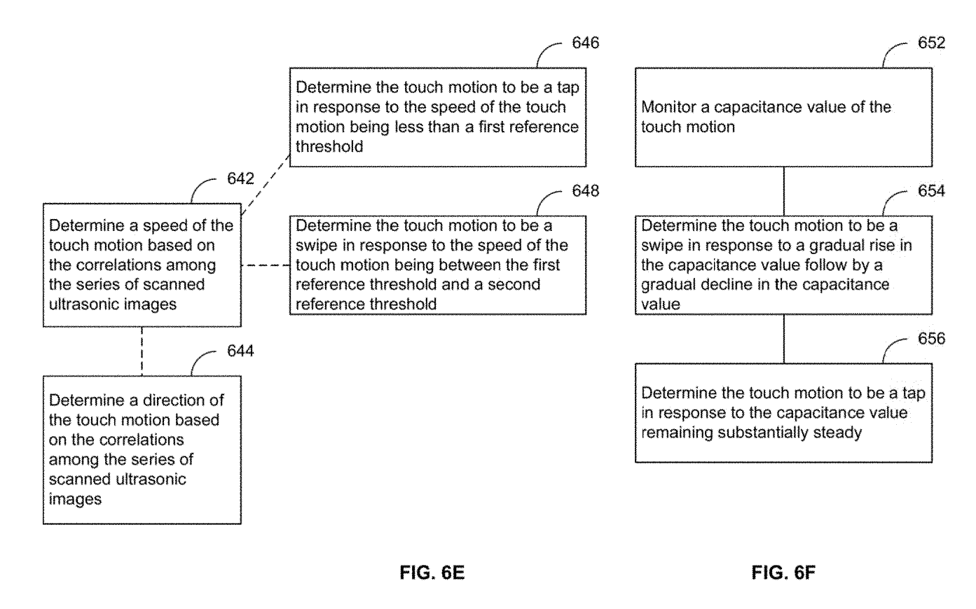

FIG. 6A illustrates a method of detecting touch motion in an imaging apparatus according to aspects of the present disclosure. In the example shown in FIG. 6A, in block 602, an ultrasonic sensor of the imaging apparatus may be configured to sense a series of scanned ultrasonic images of a touch motion. In block 604, a controller of the imaging apparatus may be configured to remove common components in the series of scanned ultrasonic images. In block 606, the controller of the imaging apparatus may be configured to determine, by the controller, correlations among the series of scanned ultrasonic images. According to aspects of the present disclosure, determining correlations among the series of scanned ultrasonic images may include performing cyclic correlations among the series of scanned ultrasonic images in frequency domain, performing linear correlations among the series of scanned ultrasonic images in time domain, or a combination thereof. In block 608, the controller of the imaging apparatus may be configured to determine a touch motion based on the correlations among the series of scanned ultrasonic images.

FIG. 6B illustrates a method of removing the mean from a series of scanned ultrasonic images according to aspects of the present disclosure. As shown in FIG. 6B, in block 612, a controller of the imaging apparatus may be configured to compute a mean of the series of scanned ultrasonic images. In block 614, the controller of the imaging apparatus may be configured to remove the mean from the series of scanned ultrasonic images.

FIG. 6C illustrates a method of summing and diluting a series of scanned ultrasonic images according to aspects of the present disclosure. In the exemplary implementation of FIG. 6C, in block 622, for each line of a scanned image in the series of scanned ultrasonic images, a controller of the imaging apparatus may be configured to partition pixels in each line into groups of equal number of pixels. In block 624, for each group of equal number of pixels, the controller of the imaging apparatus may be configured to compute an average pixel value to represent each group of equal number of pixels. In block 626, the controller of the imaging apparatus may be configured to determine correlations among the series of scanned ultrasonic images using the average pixel value from each group of equal number of pixels.

FIG. 6D illustrates a method of removing common components from a series of scanned ultrasonic images according to aspects of the present disclosure. In the example of FIG. 6D, in block 632, a controller of the imaging apparatus may be configured to acquire background image information based on an acquisition time delay and an ultrasonic transmitter frequency. In block 634, the controller of the imaging apparatus may be configured to compute a background estimate using the background image information. In block 636, the controller of the imaging apparatus may be configured to remove the background estimate from the series of scanned ultrasonic images.

FIG. 6E illustrates a method of determining a touch motion based on correlations among the series of scanned ultrasonic images according to aspects of the present disclosure. As shown in the exemplary implementation of FIG. 6E, in block 642, a controller of the imaging apparatus may be configured to determine a speed of the touch motion based on the correlations among the series of scanned ultrasonic images. In some implementations, the method performed in block 642 may optionally or additionally include the method performed in block 644. In block 644, the controller of the imaging apparatus may be configured to determine a direction of the touch motion based on the correlations among the series of scanned ultrasonic images.

According to aspects of the present disclosure, the method performed in block 642 may optionally or additionally include the methods performed in blocks 646 to 648. In block 646, the controller of the imaging apparatus may be configured to determine the touch motion to be a tap in response to the speed of the touch motion being less than a first reference threshold. In block 648, the controller of the imaging apparatus may be configured to determine the touch motion to be a swipe in response to the speed of the touch motion being between the first reference threshold and a second reference threshold. In some implementations, the controller of the imaging apparatus may be configured to generate a feedback message in response to the speed of the touch motion being larger than the second threshold.

In some implementations, one or more capacitance measurements may be used in combination with the measurements made by the ultrasonic sensor to enhance the accuracy of the touch motion detection. The controller of the imaging apparatus may be configured to measure capacitance values while a finger is touching the glass platen attached to the ultrasonic sensor. These measurements may be performed in a repetitive manner such that the measurements may be used to improve the accuracy of the touch motion detection.

In one approach, the capacitance measured may be proportional to the coverage size of the finger over the sensor area. Thus, in situations of a swipe where a finger swipes over the sensor, for example from side to side, a gradual rise in the capacitance value to a certain maximum and then a gradual decline in the capacitance value until such a point that the finger may be no longer affecting the capacitance value may be observed. In situation of a tap, the value of the measured capacitance may be substantially steady for the duration of the tap when a finger is in contact with the sensor platen.

FIG. 6F illustrates another exemplary method of determining a touch motion according to aspects of the present disclosure. As shown in FIG. 6F, in block 652, a controller of the imaging apparatus may be configured to monitor a capacitance value of the touch motion. In block 654, the controller of the imaging apparatus may be configured to determine the touch motion to be a swipe in response to a gradual rise in the capacitance value follow by a gradual decline in the capacitance value. In block 656, the controller of the imaging apparatus may be configured to determine the touch motion to be a tap in response to the capacitance value remaining substantially steady.

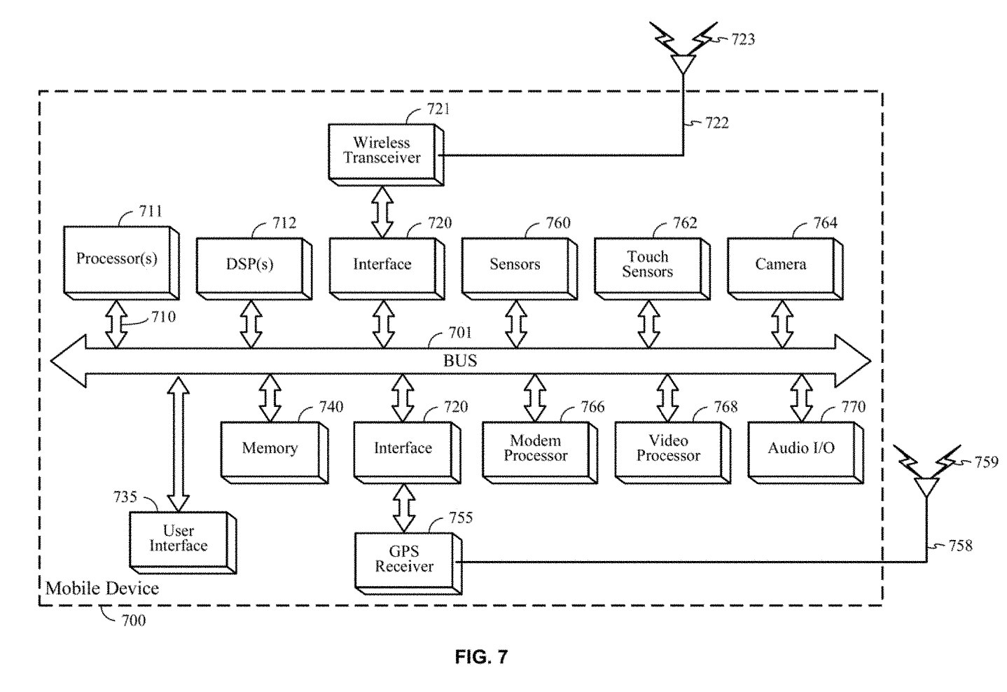

FIG. 7 illustrates an exemplary block diagram of a device that may be configured to implement the methods and apparatuses for detecting touch motion with an ultrasonic sensor according to aspects of the present disclosure. A device that may implement detecting touch motion with an ultrasonic sensor may include one or more features of mobile device 700 shown in FIG. 7. In certain embodiments, mobile device 700 may include a wireless transceiver 721 that is capable of transmitting and receiving wireless signals 723 via wireless antenna 722 over a wireless communication network. Wireless transceiver 721 may be connected to bus 701 by a wireless transceiver bus interface 720. Wireless transceiver bus interface 720 may, in some embodiments be at least partially integrated with wireless transceiver 721. Some embodiments may include multiple wireless transceivers 721 and wireless antennas 722 to enable transmitting and/or receiving signals according to a corresponding multiple wireless communication standards such as, for example, versions of IEEE Std. 802.11, CDMA, WCDMA, LTE, UMTS, GSM, AMPS, Zigbee and Bluetooth®, etc.

Mobile device 700 may also include GPS receiver 755 capable of receiving and acquiring GPS signals 759 via GPS antenna 758. GPS receiver 755 may also process, in whole or in part, acquired GPS signals 759 for estimating a location of a mobile device. In some embodiments, processor(s) 711, memory 740, DSP(s) 712 and/or specialized processors (not shown) may also be utilized to process acquired GPS signals, in whole or in part, and/or calculate an estimated location of mobile device 700, in conjunction with GPS receiver 755. Storage of GPS or other signals may be performed in memory 740 or registers (not shown).

Also shown in FIG. 7, mobile device 700 may include digital signal processor(s) (DSP(s)) 712 connected to the bus 701 by a bus interface 710, processor(s) 711 connected to the bus 701 by a bus interface 710 and memory 740. Bus interface 710 may be integrated with the DSP(s) 712, processor(s) 711 and memory 740. In various embodiments, functions may be performed in response to execution of one or more machine-readable instructions stored in memory 740 such as on a computer-readable storage medium, such as RAM, ROM, FLASH, or disc drive, just to name a few examples. The one or more instructions may be executable by processor(s) 711, specialized processors, or DSP(s) 712. Memory 740 may include a non-transitory processor-readable memory and/or a computer-readable memory that stores software code (programming code, instructions, etc.) that are executable by processor(s) 711 and/or DSP(s) 712 to perform functions described herein. In a particular implementation, wireless transceiver 721 may communicate with processor(s) 711 and/or DSP(s) 712 through bus 701 to enable mobile device 700 to be configured as a wireless station. Processor(s) 711 and/or DSP(s) 712 may perform the methods and functions, and execute instructions to execute one or more aspects of processes/methods discussed in connection with FIG. 1 to FIG. 6F and FIG. 8 to FIG. 9B.

Also shown in FIG. 7, a user interface 735 may include any one of several devices such as, for example, a speaker, microphone, display device, vibration device, keyboard, touch screen, etc. A user interface signal provided to a user may be one or more outputs provided by any of the speaker, microphone, display device, vibration device, keyboard, touch screen, etc. In a particular implementation, user interface 735 may enable a user to interact with one or more applications hosted on mobile device 700. For example, devices of user interface 735 may store analog or digital signals on memory 740 to be further processed by DSP(s) 712 or processor 711 in response to action from a user. Similarly, applications hosted on mobile device 700 may store analog or digital signals on memory 740 to present an output signal to a user. In another implementation, mobile device 700 may optionally include a dedicated audio input/output (I/O) device 770 comprising, for example, a dedicated speaker, microphone, digital to analog circuitry, analog to digital circuitry, amplifiers and/or gain control. In another implementation, mobile device 700 may include touch sensors 762 responsive to touching, pressure, or ultrasonic signals on a keyboard or touch screen device.

Mobile device 700 may also include a dedicated camera device 764 for capturing still or moving imagery. Dedicated camera device 764 may include, for example an imaging sensor (e.g., charge coupled device or CMOS imager), lens, analog to digital circuitry, frame buffers, etc. In one implementation, additional processing, conditioning, encoding or compression of signals representing captured images may be performed at processor 711 or DSP(s) 712. Alternatively, a dedicated video processor 768 may perform conditioning, encoding, compression or manipulation of signals representing captured images. Additionally, dedicated video processor 768 may decode/decompress stored image data for presentation on a display device (not shown) on mobile device 700.

Mobile device 700 may also include sensors 760 coupled to bus 701 which may include, for example, inertial sensors and environmental sensors. Inertial sensors of sensors 760 may include, for example accelerometers (e.g., collectively responding to acceleration of mobile device 700 in three dimensions), one or more gyroscopes or one or more magnetometers (e.g., to support one or more compass applications). Environmental sensors of mobile device 700 may include, for example, temperature sensors, barometric pressure sensors, ambient light sensors, and camera imagers, microphones, just to name few examples. Sensors 760 may include one or more ultrasonic fingerprint sensors. Sensors 760 may generate analog or digital signals that may be stored in memory 740 and processed by DPS(s) or processor 711 in support of one or more applications such as, for example, applications directed to positioning or navigation operations.

In a particular implementation, mobile device 700 may include a dedicated modem processor 766 capable of performing baseband processing of signals received and down-converted at wireless transceiver 721 or GPS receiver 755. Similarly, dedicated modem processor 766 may perform baseband processing of signals to be up-converted for transmission by wireless transceiver 721. In alternative implementations, instead of having a dedicated modem processor, baseband processing may be performed by a processor or DSP (e.g., processor 711 or DSP(s) 712).

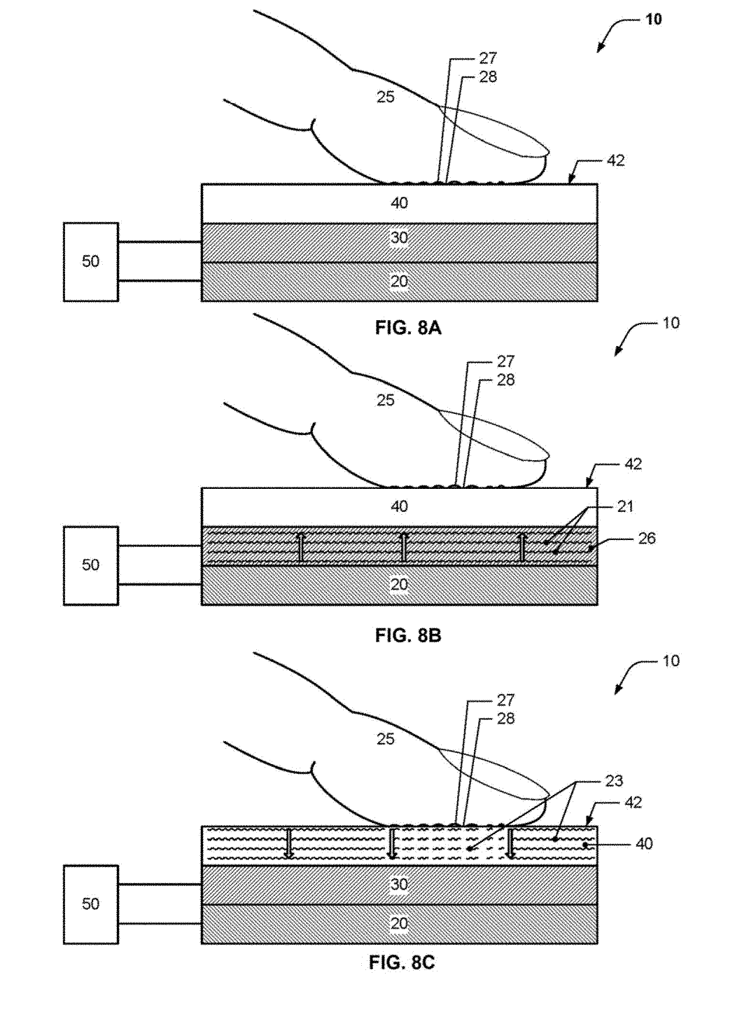

FIGS. 8A-8C illustrate an example of an ultrasonic sensor according to aspects of the present disclosure. As shown in FIG. 8A, an ultrasonic sensor 10 may include an ultrasonic transmitter 20 and an ultrasonic receiver 30 under a platen 40. The ultrasonic transmitter 20 may be a piezoelectric transmitter that can generate ultrasonic waves 21 (see FIG. 8B). The ultrasonic receiver 30 may include a piezoelectric material and an array of pixel circuits disposed in or on a substrate. In some implementations, the substrate may be a glass, plastic or semiconductor substrate such as a silicon substrate. In operation, the ultrasonic transmitter 20 may generate one or more ultrasonic waves that travel through the ultrasonic receiver 30 to the exposed surface 42 of the platen 40. At the exposed surface 42 of the platen 40, the ultrasonic energy may be transmitted, absorbed or scattered by an object 25 that is in contact with the platen 40, such as the skin of a fingerprint ridge 28, or reflected back. In those locations where air contacts the exposed surface 42 of the platen 40, e.g., valleys 27 between fingerprint ridges 28, most of the ultrasonic wave will be reflected back toward the ultrasonic receiver 30 for detection (see FIG. 8C). Control electronics 50 may be coupled to the ultrasonic transmitter 20 and ultrasonic receiver 30 and may supply timing signals that cause the ultrasonic transmitter 20 to generate one or more ultrasonic waves 21. The control electronics 50 may then receive signals from the ultrasonic receiver 30 that are indicative of reflected ultrasonic energy 23. The control electronics 50 may use output signals received from the ultrasonic receiver 30 to construct a digital image of the object 25. In some implementations, the control electronics 50 may also, over time, successively sample the output signals to detect the presence and/or movement of the object 25.

According to aspects of the present disclosure, the ultrasonic transmitter 20 may be a plane wave generator including a substantially planar piezoelectric transmitter layer. Ultrasonic waves may be generated by applying a voltage to the piezoelectric layer to expand or contract the layer, depending upon the signal applied, thereby generating a plane wave. The voltage may be applied to the piezoelectric transmitter layer via a first transmitter electrode and a second transmitter electrode. In this fashion, an ultrasonic wave may be made by changing the thickness of the layer via a piezoelectric effect. This ultrasonic wave travels toward a finger (or other object to be detected), passing through the platen 40. A portion of the wave not absorbed or transmitted by the object to be detected may be reflected so as to pass back through the platen 40 and be received by the ultrasonic receiver 30. The first and second transmitter electrodes may be metallized electrodes, for example, metal layers that coat opposing sides of the piezoelectric transmitter layer.

The ultrasonic receiver 30 may include an array of pixel circuits disposed in or on a substrate, which also may be referred to as a wafer or a backplane, and a piezoelectric receiver layer. In some implementations, each pixel circuit may include one or more silicon or thin-film transistor (TFT) elements, electrical interconnect traces and, in some implementations, one or more additional circuit elements such as diodes, capacitors, and the like. Each pixel circuit may be configured to convert an electric charge generated in the piezoelectric receiver layer proximate to the pixel circuit into an electrical signal. Each pixel circuit may include a pixel input electrode that electrically couples the piezoelectric receiver layer to the pixel circuit.

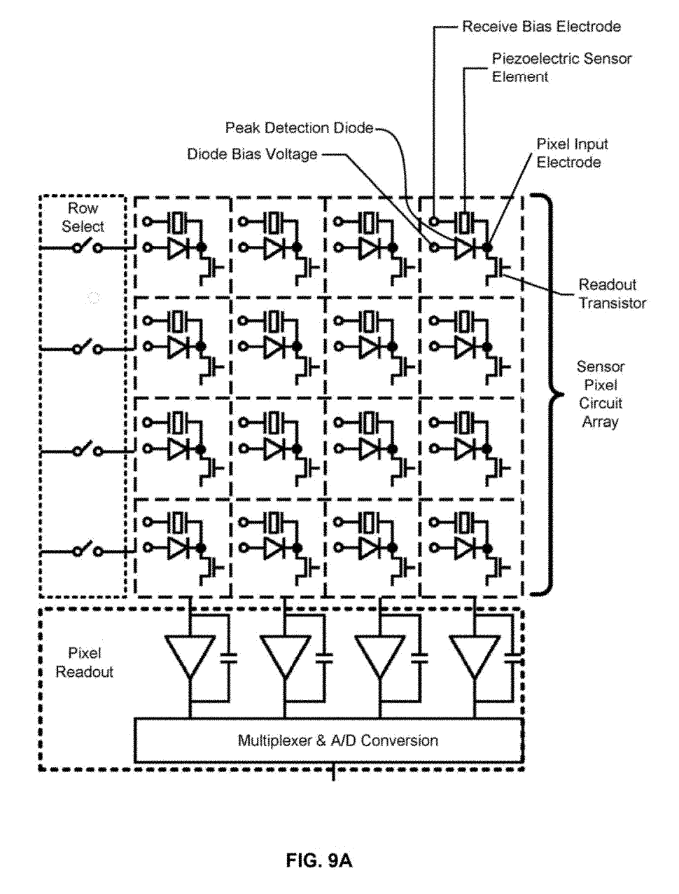

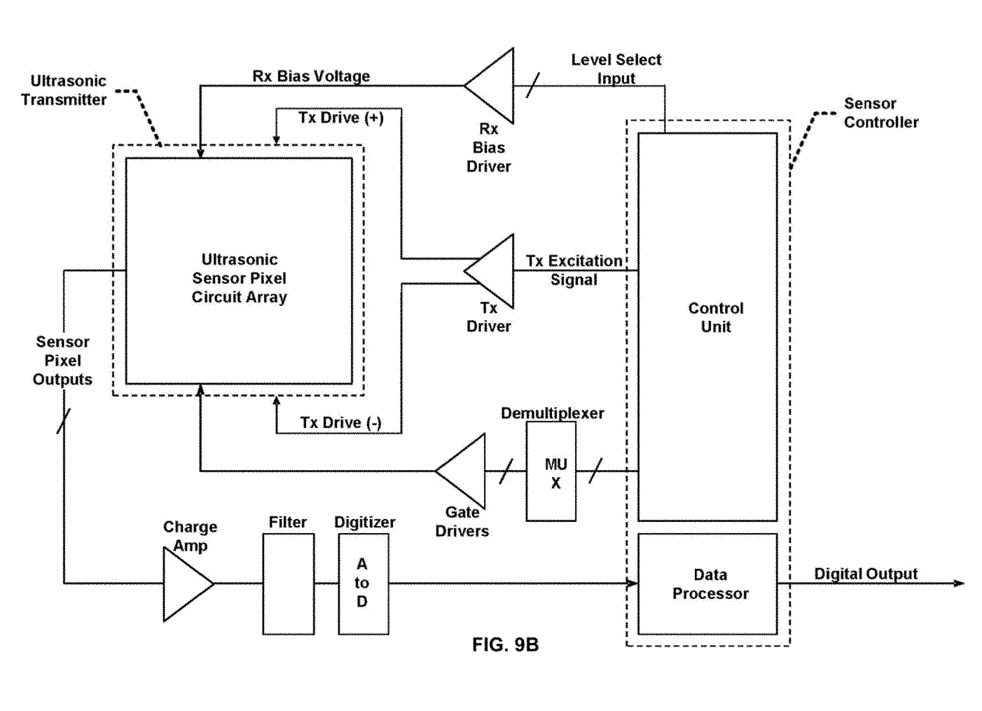

In the illustrated implementation, a receiver bias electrode is disposed on a side of the piezoelectric receiver layer proximal to platen 40. The receiver bias electrode may be a metallized electrode and may be grounded or biased to control which signals are passed to the silicon or TFT sensor array. Ultrasonic energy that is reflected from the exposed (top) surface 42 of the platen 40 is converted into localized electrical charges by the piezoelectric receiver layer. These localized charges are collected by the pixel input electrodes and are passed on to the underlying pixel circuits. The charges may be amplified by the pixel circuits and provided to the control electronics, which processes the output signals. A simplified schematic of an example pixel circuit is shown in FIG. 9A, however one of ordinary skill in the art will appreciate that many variations of and modifications to the example pixel circuit shown in the simplified schematic may be contemplated.

Control electronics 50 may be electrically connected to the first transmitter electrode and the second transmitter electrode, as well as to the receiver bias electrode and the pixel circuits in or on the substrate. The control electronics 50 may operate substantially as discussed previously with respect to FIGS. 8A-8C.

The platen 40 may be any appropriate material that can be acoustically coupled to the receiver, with examples including plastic, ceramic, glass, sapphire, stainless steel, aluminum, a metal, a metal alloy, polycarbonate, a polymeric material, or a metal-filled plastic. In some implementations, the platen 40 may be a cover plate, e.g., a cover glass or a lens glass for a display device or an ultrasonic sensor. Detection and imaging may be performed through relatively thick platens if desired, e.g., 3 mm and above.

Examples of piezoelectric materials that may be employed according to various implementations include piezoelectric polymers having appropriate acoustic properties, for example, acoustic impedance between about 2.5 MRayls and 5 MRayls. Specific examples of piezoelectric materials that may be employed include ferroelectric polymers such as polyvinylidene fluoride (PVDF) and polyvinylidene fluoride-trifluoroethylene (PVDF-TrFE) copolymers. Examples of PVDF copolymers include 60:40 (molar percent) PVDF-TrFE, 70:30 PVDF-TrFE, 80:20 PVDF-TrFE, and 90:10 PVDR-TrFE. Other examples of piezoelectric materials that may be employed include polyvinylidene chloride (PVDC) homopolymers and copolymers, polytetrafluoroethylene (PTFE) homopolymers and copolymers, and diisopropylammonium bromide (DIPAB).

The thickness of each of the piezoelectric transmitter layer and the piezoelectric receiver layer may be selected so as to be suitable for generating and receiving ultrasonic waves. In one example, a PVDF piezoelectric transmitter layer may be approximately 28 μm thick and a PVDF-TrFE receiver layer may be approximately 12 μm thick. Example frequencies of the ultrasonic waves are in the range of 5 MHz to 30 MHz, with wavelengths on the order of a quarter of a millimeter or less.

FIGS. 8A-8C show example arrangements of ultrasonic transmitters and receivers in an ultrasonic sensor, with other arrangements possible. For example, in some implementations, the ultrasonic transmitter 20 may be above the ultrasonic receiver 30, i.e., closer to the object of detection. In some implementations, the piezoelectric receiver layer may serve as both an ultrasonic transmitter and an ultrasonic receiver. A piezoelectric layer that may serve as either an ultrasonic transmitter or an ultrasonic receiver may be referred to as a piezoelectric transceiver layer or as a single-layer transmitter/receiver layer. In some implementations, the ultrasonic sensor may include an acoustic delay layer. For example, an acoustic delay layer may be incorporated into the ultrasonic sensor 10 between the ultrasonic transmitter 20 and the ultrasonic receiver 30. An acoustic delay layer may be employed to adjust the ultrasonic pulse timing, and at the same time electrically insulate the ultrasonic receiver 30 from the ultrasonic transmitter 20. The delay layer may have a substantially uniform thickness, with the material used for the delay layer and/or the thickness of the delay layer selected to provide a desired delay in the time for reflected ultrasonic energy to reach the ultrasonic receiver 30. In doing so, the range of time during which an energy pulse that carries information about the object by virtue of having been reflected by the object may be made to arrive at the ultrasonic receiver 30 during a time range when it is unlikely that energy reflected from other parts of the ultrasonic sensor 10 is arriving at the ultrasonic receiver 30. In some implementations, the silicon or TFT substrate and/or the platen 40 may serve as an acoustic delay layer.

FIG. 9A depicts a 4×4 pixel array of pixels for an ultrasonic sensor. Each pixel may, for example, be associated with a local region of piezoelectric sensor material, a peak detection diode and a readout transistor; many or all of these elements may be formed on or in the backplane to form the pixel circuit. In practice, the local region of piezoelectric sensor material of each pixel may transduce received ultrasonic energy into electrical charges. The peak detection diode may register the maximum amount of charge detected by the local region of piezoelectric sensor material. Each row of the pixel array may then be scanned, e.g., through a row select mechanism, a gate driver, or a shift register, and the readout transistor for each column may be triggered to allow the magnitude of the peak charge for each pixel to be read by additional circuitry, e.g., a multiplexer and an A/D converter. The pixel circuit may include one or more silicon transistors or TFTs to allow gating, addressing, and resetting of the pixel.

Each pixel circuit may provide information about a small portion of the object detected by the ultrasonic sensor 10. While, for convenience of illustration, the example shown in FIG. 9A is of a relatively coarse resolution, ultrasonic sensors having a resolution on the order of 500 pixels per inch or higher may be configured with a layered structure. The detection area of the ultrasonic sensor 10 may be selected depending on the intended object of detection. For example, the detection area (e.g., active area) may range from about 5 mm×5 mm for a single finger to about 3 inches×3 inches for four fingers. Smaller and larger areas, including square, rectangular and non-rectangular geometries, may be used as appropriate for the object.

FIG. 9B shows an example of a high-level block diagram of an ultrasonic sensor system. Many of the elements shown may form part of control electronics 50. A sensor controller may include a control unit that is configured to control various aspects of the sensor system, e.g., ultrasonic transmitter timing and excitation waveforms, bias voltages for the ultrasonic receiver and pixel circuitry, pixel addressing, signal filtering and conversion, readout frame rates, and so forth. The sensor controller may also include a data processor that receives data from the ultrasonic sensor circuit pixel array. The data processor may translate the digitized data into image data of a fingerprint or format the data for further processing.

For example, the control unit may send a transmitter (Tx) excitation signal to a Tx driver at regular intervals to cause the Tx driver to excite the ultrasonic transmitter and produce planar ultrasonic waves. The control unit may send level select input signals through a receiver (Rx) bias driver to bias the receiver bias electrode and allow gating of acoustic signal detection by the pixel circuitry. A demultiplexer may be used to turn on and off gate drivers that cause a particular row or column of sensor pixel circuits to provide sensor output signals. Output signals from the pixels may be sent through a charge amplifier, a filter such as an RC filter or an anti-aliasing filter, and a digitizer to the data processor. Note that portions of the system may be included on the silicon or TFT substrate and other portions may be included in an associated integrated circuit (e.g., an ASIC).

According to aspects of the present disclosure, an ultrasonic sensor may be configured to produce high-resolution fingerprint images for user verification and authentication. In some implementations, the ultrasonic sensor may be configured to detect reflected signals proportional to the differential acoustic impedance between an outer surface of a platen and a finger ridge (tissue) and valley (air). For example, a portion of the ultrasonic wave energy of an ultrasonic wave may be transmitted from the sensor into finger tissue in the ridge areas while the remaining portion of the ultrasonic wave energy is reflected back towards the sensor, whereas a smaller portion of the wave may be transmitted into the air in the valley regions of the finger while the remaining portion of the ultrasonic wave energy is reflected back to the sensor.

Note that at least the following three paragraphs. FIG. 1 through FIGS. 9A-9B and their corresponding descriptions provide support for sensor means for sensing a series of scanned ultrasonic images of a touch motion; memory means for storing the series of scanned ultrasonic images; controller means for removing common components in the series of scanned ultrasonic images, determining correlations among the series of scanned ultrasonic images, and determining the touch motion based on the correlations among the series of scanned ultrasonic images; means for computing a mean of the series of scanned ultrasonic images; means for removing the mean from the series of scanned ultrasonic images; means for partitioning pixels in each line into groups of equal number of pixels; means for determining correlations among the series of scanned ultrasonic images using the average pixel value from each group of equal number of pixels; means for acquiring background image information based on an acquisition time delay and an ultrasonic transmitter frequency; means for computing a background estimate using the background image information; means for removing the background estimate from the series of scanned ultrasonic images; means for performing cyclic correlations among the series of scanned ultrasonic images in frequency domain; means for performing linear correlations among the series of scanned ultrasonic images in time domain; means for determining a speed of the touch motion based on the correlations among the series of scanned ultrasonic images; means for determining the touch motion to be a tap in response to the speed of the touch motion being less than a first reference threshold; means for determining the touch motion to be a swipe in response to the speed of the touch motion being between the first reference threshold and a second reference threshold; means for determining a direction of the touch motion based on the correlations among the series of scanned ultrasonic images; means for monitoring a capacitance value of the touch motion; means for determining the touch motion to be a swipe in response to a gradual rise in the capacitance value follow by a gradual decline in the capacitance value; and means for determining the touch motion to be a tap in response to the capacitance value remaining substantially steady.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may include an IEEE 802.11x network, and a WPAN may include a Bluetooth network, an IEEE 802.15x, for example. Wireless communication implementations described herein may also be used in connection with any combination of WWAN, WLAN or WPAN.

In another aspect, as previously mentioned, a wireless transmitter or access point may include a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may include electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

We claim:

1. A method of detecting a touch motion with an ultrasonic sensor in an imaging apparatus, the method comprising:
sensing, by the ultrasonic sensor of the imaging apparatus, a series of scanned ultrasonic images of the touch motion;
removing, by a controller of the imaging apparatus, common components in the series of scanned ultrasonic images;
determining, by the controller, correlations among the series of scanned ultrasonic images; and
determining, by the controller, the touch motion based on the correlations among the series of scanned ultrasonic images.

2. The method of claim 1, further comprising:
computing a mean of the series of scanned ultrasonic images; and
removing the mean from the series of scanned ultrasonic images.

3. The method of claim 1, further comprising:
for each line of a scanned image in the series of scanned ultrasonic images, partitioning pixels in the each line into groups of equal number of pixels;
for each group of equal number of pixels, computing an average pixel value to represent the each group of equal number of pixels; and
determining correlations among the series of scanned ultrasonic images using the average pixel value from the each group of equal number of pixels.

4. The method of claim 1, wherein removing common components in the series of scanned ultrasonic images comprises:
acquiring background image information based on an acquisition time delay and an ultrasonic transmitter frequency;
computing a background estimate using the background image information; and
removing the background estimate from the series of scanned ultrasonic images.

5. The method of claim 1, wherein determining correlations among the series of scanned ultrasonic images comprises:
performing cyclic correlations among the series of scanned ultrasonic images in frequency domain;
performing linear correlations among the series of scanned ultrasonic images in time domain; or
a combination thereof.

6. The method of claim 1, wherein determining the touch motion based on the correlations among the series of scanned ultrasonic images comprises:
determining a speed of the touch motion based on the correlations among the series of scanned ultrasonic images.

7. The method of claim 6, further comprising:
determining the touch motion to be a tap in response to the speed of the touch motion being less than a first reference threshold; and
determining the touch motion to be a swipe in response to the speed of the touch motion being between the first reference threshold and a second reference threshold.

8. The method of claim 1, wherein determining the touch motion based on the correlations among the series of scanned ultrasonic images further comprises:
determining a direction of the touch motion based on the correlations among the series of scanned ultrasonic images.

9. The method of claim 1, further comprising:
monitoring a capacitance value of the touch motion;
determining the touch motion to be a swipe in response to a gradual rise in the capacitance value follow by a gradual decline in the capacitance value; and
determining the touch motion to be a tap in response to the capacitance value remaining substantially steady.

10. An imaging apparatus configured to detect a touch motion with an ultrasonic sensor, comprising:
an ultrasonic sensor configured to sense a series of scanned ultrasonic images of the touch motion;
a memory configured to store the series of scanned ultrasonic images; and
a controller configured to:
remove common components in the series of scanned ultrasonic images;
determine correlations among the series of scanned ultrasonic images; and
determine the touch motion based on the correlations among the series of scanned ultrasonic images.

11. The imaging apparatus of claim 10, wherein the controller is further configured to:
compute a mean of the series of scanned ultrasonic images; and
remove the mean from the series of scanned ultrasonic images.

12. The imaging apparatus of claim 10, wherein the controller is further configured to:
for each line of a scanned image in the series of scanned ultrasonic images, partition pixels in the each line into groups of equal number of pixels;
for each group of equal number of pixels, compute an average pixel value to represent the each group of equal number of pixels; and
determine correlations among the series of scanned ultrasonic images using the average pixel value from the each group of equal number of pixels.

13. The imaging apparatus of claim 10, wherein the controller is further configured to:
acquire background image information based on an acquisition time delay and an ultrasonic transmitter frequency;
compute a background estimate using the background image information; and
remove the background estimate from the series of scanned ultrasonic images.

14. The imaging apparatus of claim 10, wherein the controller is further configured to:
perform cyclic correlations among the series of scanned ultrasonic images in frequency domain;
perform linear correlations among the series of scanned ultrasonic images in time domain; or
a combination thereof.

15. The imaging apparatus of claim 10, wherein the controller is further configured to:
determine a speed of the touch motion based on the correlations among the series of scanned ultrasonic images.

16. The imaging apparatus of claim 15, wherein the controller is further configured to:
determine the touch motion to be a tap in response to the speed of the touch motion being less than a first reference threshold; and
determine the touch motion to be a swipe in response to the speed of the touch motion being between the first reference threshold and a second reference threshold.

17. The imaging apparatus of claim 10, wherein the controller is further configured to:
determine a direction of the touch motion based on the correlations among the series of scanned ultrasonic images.

18. The imaging apparatus of claim 10, wherein the controller is further configured to:
monitor a capacitance value of the touch motion;
determine the touch motion to be a swipe in response to a gradual rise in the capacitance value follow by a gradual decline in the capacitance value; and
determine the touch motion to be a tap in response to the capacitance value remaining substantially steady.

19. An imaging apparatus, comprising:
sensor means for sensing a series of scanned ultrasonic images of a touch motion;
memory means for storing the series of scanned ultrasonic images; and
controller means for:
removing common components in the series of scanned ultrasonic images;
determining correlations among the series of scanned ultrasonic images; and
determining the touch motion based on the correlations among the series of scanned ultrasonic images.

20. The imaging apparatus of claim 19, further comprising:
means for computing a mean of the series of scanned ultrasonic images; and
means for removing the mean from the series of scanned ultrasonic images.

21. The imaging apparatus of claim 19, further comprising:
for each line of a scanned image in the series of scanned ultrasonic images,
means for partitioning pixels in the each line into groups of equal number of pixels;
for each group of equal number of pixels, means for computing an average pixel value to represent the each group of equal number of pixels; and
means for determining correlations among the series of scanned ultrasonic images using the average pixel value from the each group of equal number of pixels.

22. The imaging apparatus of claim 19, wherein the means for removing common components in the series of scanned ultrasonic images comprises:
means for acquiring background image information based on an acquisition time delay and an ultrasonic transmitter frequency;
means for computing a background estimate using the background image information; and
means for removing the background estimate from the series of scanned ultrasonic images.

23. The imaging apparatus of claim 19, wherein the means for determining correlations among the series of scanned ultrasonic images comprises:
means for performing cyclic correlations among the series of scanned ultrasonic images in frequency domain;
means for performing linear correlations among the series of scanned ultrasonic images in time domain; or
a combination thereof.

24. The imaging apparatus of claim 19, wherein the means for determining the touch motion based on the correlations among the series of scanned ultrasonic images comprises:
means for determining a speed of the touch motion based on the correlations among the series of scanned ultrasonic images.

25. The imaging apparatus of claim 24, further comprising:
means for determining the touch motion to be a tap in response to the speed of the touch motion being less than a first reference threshold; and
means for determining the touch motion to be a swipe in response to the speed of the touch motion being between the first reference threshold and a second reference threshold.

26. The imaging apparatus of claim 19, wherein the means for determining the touch motion based on the correlations among the series of scanned ultrasonic images further comprises:
means for determining a direction of the touch motion based on the correlations among the series of scanned ultrasonic images.

27. The imaging apparatus of claim 19, further comprising:
means for monitoring a capacitance value of the touch motion;
means for determining the touch motion to be a swipe in response to a gradual rise in the capacitance value follow by a gradual decline in the capacitance value; and
means for determining the touch motion to be a tap in response to the capacitance value remaining substantially steady.

28. A non-transitory medium storing instructions for execution by one or more processors, the instructions comprising:
instructions for sensing, by an ultrasonic sensor of the imaging apparatus, a series of scanned ultrasonic images of a touch motion;
instructions for removing, by a controller of the imaging apparatus, common components in the series of scanned ultrasonic images;
instructions for determining, by the controller, correlations among the series of scanned ultrasonic images; and
instructions for determining, by the controller, the touch motion based on the correlations among the series of scanned ultrasonic images.

29. The non-transitory medium of claim 28, wherein the instructions for determining the touch motion based on the correlations among the series of scanned ultrasonic images comprises:
instructions for determining a speed of the touch motion based on the correlations among the series of scanned ultrasonic images.

30. The non-transitory medium of claim 29, further comprising:
instructions for determining the touch motion to be a tap in response to the speed of the touch motion being less than a first reference threshold; and
instructions for determining the touch motion to be a swipe in response to the speed of the touch motion being between the first reference threshold and a second reference threshold.
